(19) United States
(12) Patent Application Publication
(10) Pub. No.: US 2009/0272606 A1
(43) Pub. Date: Nov. 5, 2009

(54) TRIPLE CHAMFER SEAL GROOVE

(75) Inventors: Galus Chelaidite, South Lyon, MI (US); Takeshi Kashimura, West Bloomfield, MI (US)

Correspondence Address: DOBRUSIN & THENNISCH PC, 29 W LAWRENCE ST, SUITE 210, PONTIAC, MI, 48342, US

(73) Assignee: AKEBONO CORPORATION (NORTH AMERICA)

(21) Appl. No.: 12/114,393

(22) Filed: May 2, 2008

(51) Int. Cl. F16D 55/18

(52) U.S. Cl. 188/72.4

(57) ABSTRACT

A brake caliper assembly that includes at least one piston bore having an exterior surface and a seal groove that includes a plurality of chamfered walls that are configured to substantially prevent piston to seal slippage at low pressures and allowing piston to seal slippage at high pressures.

### FIELD OF THE INVENTION

The present invention generally relates to seal grooves and more particularly to a chamfered groove that is especially suited for use in a brake assembly.

### BACKGROUND OF THE INVENTION

Current disc brake systems generally include a caliper which, during a brake application (e.g., brake-on position), develops clamping force to move brake pads in the wheel axial direction onto an annular braking path of the rotor. The clamping force maybe created as a result of increasing fluid pressure in a piston bore of the caliper body which forces a piston towards the rotor. Brake fluid leakage can be prevented by a rubber seal installed between the caliper body and the piston. The rubber seal is typically installed inside a groove (e.g., a seal groove), which is defined in (e.g., machined into) the caliper body piston bore. The seal, the seal groove, and the piston dimensions are such that when the piston is inserted into the bore, an interference fit is created so that the seal is deformed against the piston's outer diameter and the bottom of the seal groove, thus preventing fluid leakage. An additional purpose of the seal is to help retract the piston after the brake apply preferably to the same position prior to the brake apply, independent of the fluid pressure. This may occur for instance due to the elastic nature of the rubber material of the seal, which will seek to reform to its normal configuration in response to elastic strain during breaking.

In a brake-on position, the piston extends towards the inboard brake pad, developing loads which cause the caliper body and brake pads to respond by deflecting. The stiffer the caliper body and brake pads, the less travel is required by the piston to achieve sufficient clamping force for braking rotor motion. Generally, the caliper deflection varies linearly with clamping force, however pad stiffness does not. Normally, the brake pad is less stiff at lower clamp forces and stiffer at higher clamp forces. The seal, the seal groove profile, and the seal interference among other factors, can affect the amount of piston retraction after various brake-on pressures.

The amount of piston retraction may be described as the average running clearance, or simply running clearance. The running clearance is defined as the average clearance between the inboard and outboard brake pads when the rotor undergoes one rotation. During a rotation of the rotor, generally, there may be alternating contact and no contact periods between the rotor and the brake pads

As such, there can be two significant and potentially competing effects on brake performance with respect to the total running clearance between the inboard and outboard brake pads and the rotor. A first effect provides that the larger the average running clearance, the lower the drag force, which may result in better fuel efficiency (e.g., reduced fuel consumption) when driving normally (e.g., brake-off position such that the driver's foot is not engaging the brake pedal). The second effect provides that the larger the running clearance, the higher the volume of brake fluid that is required to achieve braking (e.g., long pedal travel), which may result in long pedal travel (e.g., longer braking periods), which is associated with poor pedal feel and thus customer complaint.

Therefore, an object of the present invention is to provide a caliper assembly with a groove seal profile that will address both the first and the second effects.

### SUMMARY OF THE INVENTION

The present invention meets the above, especially the need for balancing fuel efficiency and hydraulic fluid usage, by providing an improved brake caliper apparatus for a brake assembly. By way of summary, the present invention is directed to a brake caliper assembly that includes at least one piston bore having an exterior surface and a seal groove that includes a groove wall defining a recess into the exterior surface of the at least one piston bore; at least one piston slidably positioned within the at least one piston bore for movement along a bore axis, the at least one piston having an exterior surface and a first piston end configured for moving the inboard brake pad; a seal arranged about the recess of the seal groove, which frictionally engages for sealing purposes on a first portion of the exterior surface of the at least one piston; and a chamfered portion including a plurality of chamfered walls that adjacently extend from a second end of the inner groove wall portion to the exterior surface of the at least one piston bore, and include a first chamfered wall extending from the second end of the inner groove wall portion to a first chamfered edge; a second chamfered wall extending from the first chamfered edge to a second chamfered edge; and the third chamfered wall extending from the second chamfered edge to an edge portion of the exterior surface of the at least one piston bore.

In one aspect of the present invention, the first chamfered wall defines a first angle that ranges from about 5° to about 50° taken from vertical with respect to the bore axis, the second chamfered wall extending from the first chamfered edge to a second chamfered edge, the second chamfered wall defining a second angle that ranges from about 50° to about 90° taken from vertical with respect to the bore axis, or both is configured to substantially prevent slippage between the seal and the first portion of the exterior surface during a brake-on position for brake assemblies of varying stiffness.

In another aspect of the present invention, the third angle is configured to allow slippage between the seal and the first portion of the exterior surface of the at least one piston during a brake-on position for brake assemblies of varying stiffness.

### BRIEF DESCRIPTION OF THE DRAWINGS

FIG. 1 shows a perspective view of one embodiment of the present invention.

FIG. 2 shows a cross-section of the perspective view of one embodiment of the present invention.

FIGS. 3-4 show an enlarged cross-section of one aspect of one embodiment of the present invention.

FIGS. 5A-6C show a cross-section of one embodiment of the present invention.

FIGS. 7A-8C show a cross-section of another embodiment of the present invention.

FIGS. 9A-10C show a cross-section of another embodiment of the present invention.

FIG. 11 shows another embodiment of the present invention.

### DETAILED DESCRIPTION OF THE INVENTION

The following description of the preferred embodiment(s) is merely exemplary in nature and is in no way intended to limit the invention, its application, or uses.

The teachings of the present invention provide a brake caliper having a piston bore that is adapted to receive a piston for movement thereabout during the engagement and disengagement of brake pads to a rotor. Desirably, the piston bore includes a groove (e.g., seal groove) profile that is configured to substantially prevent piston to seal slippage at low hydraulic pressures while allowing piston to seal slippage at higher hydraulic pressures so as to balance the effects of drag force and hydraulic fluid volume in a braking system (e.g., ranging in stiffness) for an automotive vehicle. This can be accomplished according to the present teachings for example, by configuring the seal groove profile with a specific series of chamfers into which the seal elastically deforms during braking (e.g., a forward edge elastically and sequentially deforms about at least two offset deformation sites) so that in a brake-on position the piston adequately supplies braking force to the inboard brake pad while the chamfers allow deformation of the seal However, in a brake-off position, the geometry of the seal groove profile may include a structure that aids to return the elastically deformed seal to its original state.

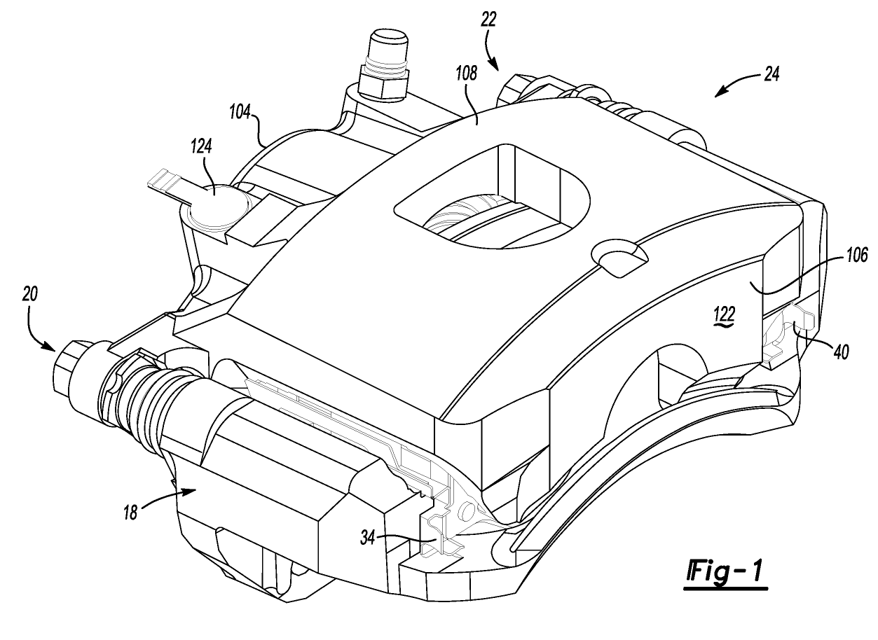

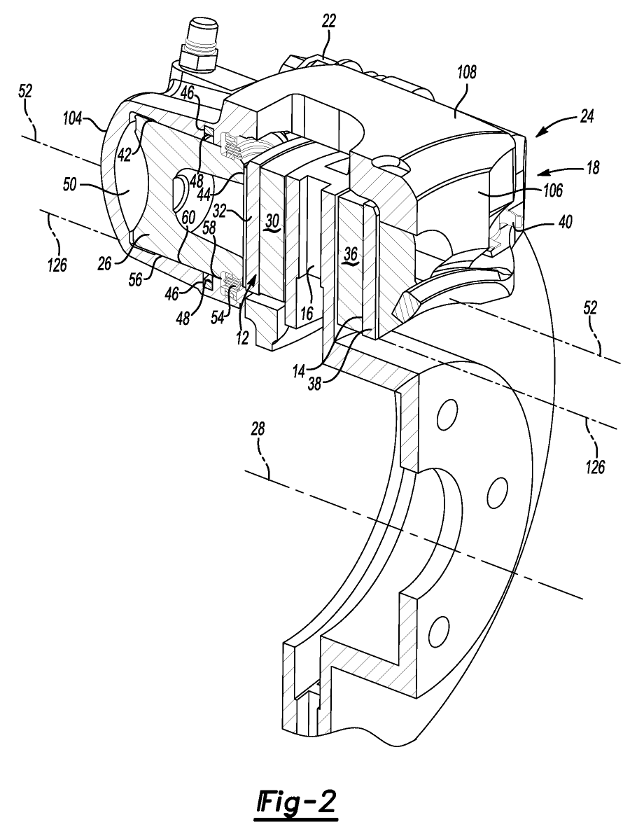

With reference to FIGS. 1 and 2, an example (without limitation) of a typical disc brake (e.g., floating disc brake) construction 10 is shown. However, it is appreciated, that the same general seal groove profile may be utilized to improve the performance of an opposed piston caliper disc brake construction (not shown). Disc brake 10 is operable to clamp an inboard brake pad 12 and an outboard brake pad 14 against a rotatable disc (e.g., rotor) 16 to decelerate a vehicle (not shown) when in a brake-on position. Disc brake 10 includes a support bracket 18 adapted to mount to a steering knuckle or axle component of the vehicle to support braking forces during operation. A caliper 24 is slidably supported on first slide pin 20 and second slide pin 22. At least one piston 26 is slidably supported within caliper 24. The piston 26 is moveable via hydraulic pressure being selectively supplied to caliper 24. Inboard brake pad 12 and outboard brake pad 14 are positioned on opposite wear surfaces of rotor 16. Caliper 24 at least partially envelops inboard brake pad 12 and outboard brake pad 14 such that axial movement of the piston 26 causes the brake pads to clamp on the rotor in a brake-on position.

Inboard brake pad 12 includes a friction material block 30 mounted on a backing plate 32. Clips 34 may cooperate to allow lateral movement of inboard brake pad 12 toward and away from rotor during and after braking. Outboard brake pad 14 includes a friction material block 36 mounted to a backing plate 38. Clips 40 may cooperate to allow lateral movement of outboard brake pad 14 toward and away from rotor during and after braking.

Caliper 24 is a generally “C” shaped member having an inboard cylinder portion 104 and an outboard finger portion 106 interconnected by a laterally extending bridge portion 108. The inboard cylinder portion 104 includes at least one piston bore 50. The piston 26 is slidably positioned within the piston bore 50 to move along a piston bore axis 52. A piston boot 54 sealingly engages the piston 26 and inboard cylinder portion 104 to protect the piston bore from ingress of contamination. The piston 26 is operable under hydraulic fluid entering a port 124 through the piston bore 50 to apply an actuating force to backing plate 32 of inboard brake pad 12. As shown in FIG. 2, the bore 50 further includes a typical groove seal 46 having a rubber seal 48 therein.

The outboard finger portion 106 includes a surface 122 in engagement with backing plate 38 of outboard brake pad 14. Because inboard brake pad 12, outboard brake pad 14, and caliper 24 are laterally moveable relative to support bracket 18 and rotor 16, both inboard brake pad 12 and outboard brake pad 14 may clamp against rotor 16.

As mentioned above, it is contemplated that in the case of an opposed piston caliper 130, at least two opposing piston bores are provided and are each adapted to receive a piston for movement thereabout during engagement and disengagement of the brake pads to a rotor 152. More specifically the at least two opposing piston bores include an inboard piston bore 132 adapted to receive an inboard piston 134 and an outboard piston bore 136 adapted to receive an outboard piston 138. The inboard and outboard pistons include inboard and outboard piston ends 140, 142 generally opposing one another.

The caliper further includes an inboard brake pad 144 and outboard brake pad 146 configured for engaging the rotor. The inboard brake pad 144 having a backing plate 148 generally adjacent to the piston end 140 of the inboard piston 134 and a friction material 150 for engaging a first portion 258 of the rotor 152. The outboard brake pad 146 having a backing plate 154 generally adjacent to the piston end 142 of the outboard piston 138 and a friction material 156 for engaging a second portion 260 of the rotor 152. As the hydraulic pressure increases in the inboard and outboard piston bores 132, 136, both of the opposing inboard and outboard pistons 134, 138 extend inward such that the inboard piston end 140 moves the inboard brake shoe 144 and the outboard piston end 142 moves the outboard brake shoe 146 inward generally towards the rotor 152, located therebetween (e.g., along generally the same or different axis).

As discussed above with respect to the “floating” disc brake, desirably, the inboard and outboard piston bores 132, 136 include a seal groove 162 with a profile having a chamfered wall portion 164 that includes a plurality of chamfered walls (e.g., a first, second and third chamfered wall, as discussed herein). The seal groove 162 adapted for receiving a seal 166 arranged about the recess of the seal groove. The seal 166 is configured to frictionally engage, for sealing purposes, on a portion of the exterior surface of the respective piston 134, 138. It is contemplated that in an opposed piston caliper, the forward portions of the groove wall and the chamfered portions may be located nearest to the rotor while the rearward portions of the respective grooves wall may be located farthest from rotor. It is appreciated that the groove seal profile is configured to substantially prevent piston to seal slippage at low hydraulic pressures while allowing piston to seal slippage at higher hydraulic pressures so as to balance the effects of drag force and hydraulic fluid volume in a braking system (e.g., ranging in stiffness) for an automotive vehicle.

It is appreciated that in an opposed piston caliper, only the pistons may move with respect to each other during a brake-on position (e.g., the caliper body does not substantially move (e.g., deflect). It is further appreciated that the seal groove profile (e.g., shape) may be generally similar though not dimensionally equal in the inboard piston bore with respect to the outboard piston bore. For example, in the case of two opposed pistons and/or leading to trailing in the case of 4 or more pistons where “leading” piston may mean that the piston “sees” a section of the rotor first, and the “trailing” piston may be the piston that “sees” that section of the rotor last (e.g., as the rotor section rotates out the back of the caliper).

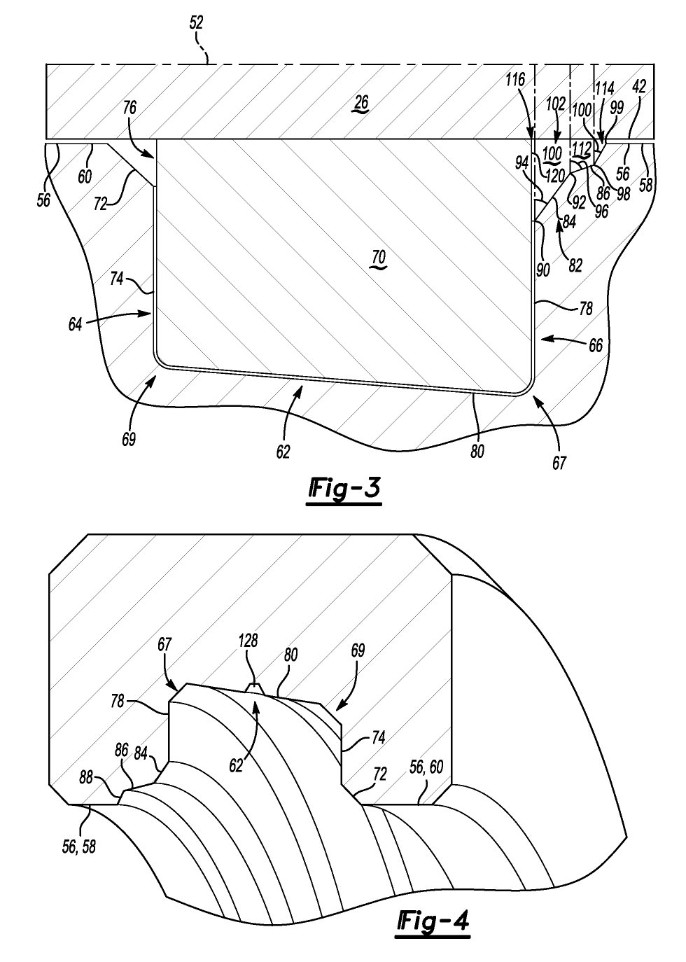

With reference to FIGS. 3 and 4, enlarged representations of the area (e.g., profile) of the seal groove 62 of the present invention are shown. The piston bore 50 includes an exterior surface 56 that defines a cavity (e.g., generally cylindrical) configured to receive the piston 26. The exterior surface 56 includes a forward exterior surface portion 58 and a rearward exterior surface portion 60 with a shaped piston seal groove 62 (e.g., generally annular), therebetween. The seal groove 62 is outwardly displaced from the exterior surface 56 to define a seal groove profile forming an area adapted to receive a piston seal 70. Advantageously, the seal groove profile is configured so as to balance the effects of drag force and hydraulic fluid volume in a braking system (e.g., ranging in stiffness) for an automotive vehicle as discussed herein.

The seal 70 may be shaped in various forms. The seal may be generally annular and includes a hollow section having an inner diameter appropriately dimensioned such that a portion of the outer diameter of the exterior surface 42 of the piston 26 may be encapsulated so as to generally form a seal thereabout. Desirably, at least a portion (e.g., outer portion) of the seal may be appropriately dimensioned to form a seal thereabout to a portion (e.g., outer groove wall) of the groove seal profile. In one specific example, the seal may include a forward outer diameter (e.g., about forward groove wall portion) which may be larger than a rearward outer diameter such that the cross-section of the seal may be a trapezoidal shape having a hollow through-hole that may be cylindrical. It is appreciated that other shapes, sizes, orientations, or otherwise may be possible.

Turning back to the groove seal 62, the forward and rearward portions 58, 60 of the exterior surface 56, extend in a generally parallel direction to the bore axis 52, though not required, and adjacently to the exterior surface 42 of the piston 26. The seal groove 62 may include a rearward portion 64 having a chamfered wall 72 extending between a rearward groove wall 74 and the rearward exterior surface 60 of the bore 50 so as to define a first recess 76. The chamfered wall 72 is spaced apart from and generally opposing the seal 70. The seal groove 62 further includes a forward portion 66, which is nearest to the inboard brake pad 12. The forward portion 66 of the seal groove 62 may include a forward groove wall 78, which generally opposes and is spaced apart from the rearward groove wall 74, with and an outer groove wall 80 extending therebetween, The forward and rearward portions 66, 64 further include outer ends 67, 69, respectively, that extend to the outer groove wall 80. The outer ends 67, 69 may be similar or different, larger or smaller, positioned displaced relative to the bore axis differently that the other, or otherwise. For example, one or both of the outer ends 67, 69 may include bending points that may be generally curved such as concave or convex (FIG. 3), flat such as sloping or chamfered (FIG. 4), apexed such as having a point or edge, or otherwise, or any combination thereof.

It is appreciated that the rearward groove wall 74, the forward groove wall 78, the outer groove wall 80, the chamfered wall 72, or any combination thereof may have a cross-section that may be flat, (e.g., sloping or otherwise), arcuate, or otherwise, or any combination thereof. By way of example, at least one of the forward and rearward groove walls 78, 74 may extend generally perpendicular to the bore axis 52 as shown in FIGS. 3 and 4 so that the seal 70 may be substantially retained about the seal groove 62 during partial deformation outward and reformation inward, thereof. In one aspect, the outer groove wall 80 may be generally sloping such that the outer end 67 of the forward portion 66 may be further outwardly displaced relative to the bore axis 52 than the outer end 69 of rearward portion 64. Sloping in the opposite direction is also a possibility. Optionally, the outer groove wall may further include a recess 128 (FIG. 4) that extends outward of the seal groove 62, and into the cylinder portion 104. Preferably, the outer groove wall 80 ends between the outer ends 67, 69 and is generally flat (in cross-section) therebetween. It is appreciated the sloping of the outer groove wall 80 is configured so that after assembly of the caliper 24 and after initial pressure applications, the seal 70 may position itself against wall 78 such that when brake is applied, the seal 70 may be directed to deform outward into a second recess 102.

The forward portion 66 of the seal groove 62 further includes a chamfered portion 82 extending between the forward groove wall 78 and the forward exterior surface 58 of the piston bore 50. The chamfered portion 82 includes a plurality of chamfered surfaces that define surrounding surfaces such that at least one chamfered surface substantially prevents piston to seal slippage in a brake-on position and at least one chamfered surface generally allows piston to seal slippage in a brake-on position. It is appreciated that when shown, the plurality of chamfered surfaces, which in cross section are shown in straight lines, though not required. In one specific example as shown in FIGS. 3 and 4, the chamfered portion 82 includes a first chamfered wall 84, a second chamfered wall 86, and a third chamfered wall 88 that adjacently extend (e.g., in series) from the forward groove wall 78 to the forward exterior surface 58 of the piston bore 50. The first, second and third chamfered walls 84, 86, and 88 and the exterior surface 42 of the piston 26 generally define a second recess 102 therebetween. The first chamfered wall 84 extends from a groove wall edge 90 of the forward groove wall 78 located opposite the outer end 67 to a first chamfered edge 92.

The first chamfered wall 84 may define a first angle 94 taken from vertical of the groove wall edge 90 with respect to the bore axis 52. The first angle 94 may be at least about 5°, and preferably at least about 25°. Furthermore, the first angle 94 may be less than about 50°, and preferably less than about 45°. For example, the first angle 94 may range from about 5° to about 50°, and preferably from about 25° to about 45°.

The first chamfered edge 92 interconnects the first chamfered wall 84 to the second chamfered wall 86. The second chamfered wall 86 may define a second angle 96 taken from vertical of the first chamfered edge 92 with respect to the bore axis 52. The second angle 96 may be at least about 30°, and preferably at least about 50°. Furthermore, the second angle 96 may be less than about 90°, and preferably less than about 70°. For example, the second angle 96 may range from about 30° to about 90°, and preferably from about 50° to about 70°.

The second chamfered wall 86 extends from the first chamfered edge 92 to a second chamfered edge 98 such that the second chamfered edge 98 interconnects the second chamfered wall 86 to the third chamfered wall 88. The third chamfered wall 88 may define a third angle 100 taken from vertical of the second chamfered edge 98 with respect to the bore axis 52. The third angle 100 may be at least about 0°, and preferably at least about 5°. Furthermore, the third angle 100 may be less than about 50°, and preferably less than about 45°. For example, the third angle 100 may range from about 0° to about 50°, and preferably from about 50 to about 45°. The third chamfered wall 88 extends from the second chamfered edge to a bore edge 99 of the forward exterior surface 58 of the bore 50.

It is contemplated that the first, second and third angles 94, 96, and 100 may not be progressively increasing or progressively decreasing, though not required. In one specific example, the second angle 96 is generally larger than both the first angle 94 and the third angle 100.

It is further appreciated that within the examples, it is shown and/or discussed that the chamfered walls may be connected to one another and/or to the groove wall, the exterior surface of the bore, or otherwise so as to define a bending portion (e.g., edge or apex shown in the cross-section). However, it is further appreciated that one or more of the bending portions therebetween may be straight, arcuate, or otherwise. In one specific example as shown in FIGS. 3 and 4, the first, second, and third chamfered walls preferably include a convex portion (e.g., the first chamfered edge 92 between the first and second chamfered walls 84, 86 being generally displaced into the second recess 110) and a concave portion (e.g., the second chamfered edge 98 between the second and third chamfered wall 86, 88 being generally displaced outward of the second recess 110). In one embodiment, the groove seal edge 90 may be located at least about 10%, typically at least about 15%, and more typically at least about 20% of the distance from the exterior surface of the piston to the outer end 67 of the forward portion of the seal groove. Furthermore, the groove wall edge 90 may be located less than about 70%, typically less than about 50%, and more typically less than about 40% of the distance from the exterior surface of the piston to the outer end 67 of the forward portion of the seal groove. For example, the groove wall edge may be located from about 10% to about 70%, typically about 15% to about 50%, and more typically about 20% to about 40% of the distance from the exterior surface of the piston to the outer end 67 of the forward portion of the seal groove. In another embodiment, the bore edge 99 may be located at least about 0.3 mm, and typically at least about 0.6 mm from the forward portion 120 of the seal in a brake-off position. Furthermore, the bore edge 99 may be located less than about 2 mm, and typically less than about 1.5 mm from the forward portion 120 of the seal in a brake-off position. For example, the bore edge 99 may be located from about 0.3 mm to about 2 mm, and typically from about 0.6 mm to about 1.5 mm from the forward portion 120 of the seal in a brake-off position.

In a brake-on position, the piston 26 extends outward to move the inboard brake pad towards the rotor to decrease an initial running clearance between one or both of the inboard and outboard brake pads 12, 14 and the rotor 16. It is appreciated that in an initial first brake-off position, the initial running clearance may be generally defined by the total distance between both the inboard and outboard brake pads and a rotor. More specifically, the total running clearance may be defined as the distance between the piston end and the backing plate of the inboard brake pad, the distance between the friction material of the inboard brake pad and a first surface of the rotor, the distance between a second surface of the rotor and the friction material of the outboard brake pad, and the distance between the backing plate of the outboard brake pad and the inboard surface of the caliper body “fingers”.

The piston continues to extend until the piston force is balanced by the deflection of one or both the caliper and the brake pads as allowed by their respective stiffness so as to engage the rotor 16. Accordingly, as the piston 26 extends outward towards the rotor, the piston 26 may force at least a portion of the seal 70 into the second recess 102 by deformation of the seal 70. The second recess 102 includes a first area 110, a second area 112, and a third area 114 generally positioned between the first, second and third chamfered walls 84, 86, and 88, and the exterior portion 42 of the piston 26, respectively. It is appreciated that as the piston 26 extends outward and begins to deform the seal 70 into the first area 110 or both the first area 110 and the second area 112 of the second recess 102, such that there may be substantially no slippage between the seal 70 and the external surface 42 of the piston 26. More particularly, as the hydraulic pressure within the piston bore 50 increases, the piston 26 may continue to extend outward while further deforming the seal 70 into the second recess 102.

It is appreciated that the amount of deformation by the seal 70 into the second recess 102 may be affected by the properties (e.g., stiffness) of friction material utilized in the inboard brake pad 12 and the outboard brake pad 14. For example, in brake systems having a relatively high stiffness, the amount of piston travel may be shorter than brake systems having a lower stiffness friction material. More specifically, at the similar hydraulic pressure, the piston will travel less with a high stiffness friction material than it will travel with a lower stiffness friction material to achieve generally similar braking. As such, the friction material having a relatively high stiffness may result in a lower degree of deformation of the seal 70 into second recess 102 than friction material having a relatively low stiffness at similar hydraulic pressures.

In one aspect, the first chamfered wall 84, the first angle 94, or both may be configured to accommodate brake pads including different friction materials such as some brake pads have a relatively high stiffness as compared with other brake pads in order to regulate the amount of deformation of the seal 70 into the first area 110 of the second recess 102. For example in a brake apparatus having a relatively high stiffness brake pads, the first chamfered wall 84 may allow a portion of the seal 70 to generally deform into the first area 110 of the second recess 102 as the piston 26 travels outward to apply a clamping force on the rotor during the brake-on position. It is appreciated that as the seal 70 moves with the piston 26 due to contact friction therebetween and increasing pressure on the seal 70, the first chamfered wall 84, the first angle 94, or both generally determine the amount the seal 70 deforms into the first area 110 so as to regulate the distance the piston 26 travels (e.g., substantially without piston to seal slippage or with piston to seal slippage depending on the hydraulic pressure).

In another aspect, the second chamfered wall 86, the second angle 96, or both may be configured to accommodate brake pads including friction material having a relatively low stiffness in order to regulate the amount of deformation of the seal 70 through the first area 110 (e.g., in substantial contact with the first chamfered wall) and into the second area 112 of the second recess 102. As such, in utilizing the combination of the first and second chamfered wall 84, 86, with respect to the first and second angles 94, 96, the brake assembly of the present invention may be equipped to accommodate several types of brake pads (e.g., having low stiffness friction material, high stiffness friction material, or any stiffness friction material in between). More specifically, by varying the first chamfered wall 84, the second chamfered wall 86, the first angle 94, the second angle 96, or any combination thereof, the groove seal configuration of the present invention may be configured to work in both low stiffness and high stiffness brake systems while “optimizing” the balance between the first and second effect (e.g., drag force and fluid volume) as discussed herein.

In yet another aspect, the third chamfered wall 88, the third angle 100, or both may be configured to allow slippage between the seal 70 and at the exterior surface 42 of the piston 26 to minimize the running clearance between the inboard and outboard brake pads 12, 14 and the rotor 16 in the following second brake-off position. By allowing slippage to occur, causing slippage to occur, or both, the piston 26 continues to extend outward towards the rotor 16 without substantially deforming the seal 70 into the third area 114 (e.g. such that the seal 70 is in substantial contact with the third chamfered wall). In doing so, a balance between the first effect (e.g., drag force) and second effect (e.g., hydraulic fluid usage) may be obtained such that in the following brake-off position, the running clearance is reduced (e.g., with respect to the running clearance of the initial first brake-off position). By balancing the first and second effects thereby reducing the running clearance, it is believed that brake pedal travel (e.g., distance brake pedal travels from first contact by foot to engagement of brakes) necessary to engage the brake assembly is decreased, without generating excessive amounts of drag force at high pressure. For example, it is believed that the drag force produced may be about 25 to about 50% less than the drag force of other brake assemblies that omit to control the amount of slip between the piston and the seal by the design characteristics of the third chamfered wall, the third angle, or both of the present invention, or otherwise to allow slippage or have reduced slippage at pressures higher than about 6 MPa.

Upon engagement of the brakes (e.g., contacting, depressing, or both the brake pedal), the vehicle transmits the force from the vehicle operator's foot to the brake assembly through hydraulic fluid (e.g., brake fluid). When the brake pedal is depressed, the pressure on the brake pedal forces the hydraulic fluid into the piston bore. As the piston bore fills with hydraulic fluid, the pressure within the piston bore increases such that the hydraulic fluid pushes the piston (and seal) from an initial position to an engagement location so as to extend the inboard brake pad, towards the rotor accordingly for engagement thereof.

The inboard brake pad may be extended towards the rotor such that upon contact with the rotor, the caliper body (104, 106, and 108) will slide on pins 20 and 22 because the piston pushes against inner brake pad which pushes against rotor which does not move axially along 52. Because rotor does not move axially along 52, the caliper body (104, 106, and 108) must slide on pins along 52 to create force on outer brake pad 14. The force created by the hydraulic pressure on the piston and thus on inner pad, is equal to the force the caliper body applies on the outer brake pad). The engagement by the inboard an outboard brake pads retards the rotation of the rotor thereby slowing the wheel rotation of the vehicle. However, in one preferred embodiment, upon engagement of the brakes (e.g., brake-on position); it may be desirable to substantially maintain a target running clearance in a brake-off position that follows a brake-on position that may achieve a hydraulic pressure that ranges from about 0 to about 7 MPa.

As discussed herein, it is appreciated that to control the amount of hydraulic fluid displacement required during the brake-on position, it may be desirable to maintain a certain level of or target running clearance. To achieve this, the distance from the exterior surface 56 of the bore to the groove wall edge 90 is important to achieve a target running clearance. Typically, the higher the brake system stiffness (e.g., reduced piston travel needed for braking) the smaller the vertical distance between a surface axis 126 (e.g., extending along the forward and rearward exterior surfaces of the bore) and the groove wall edge 90.

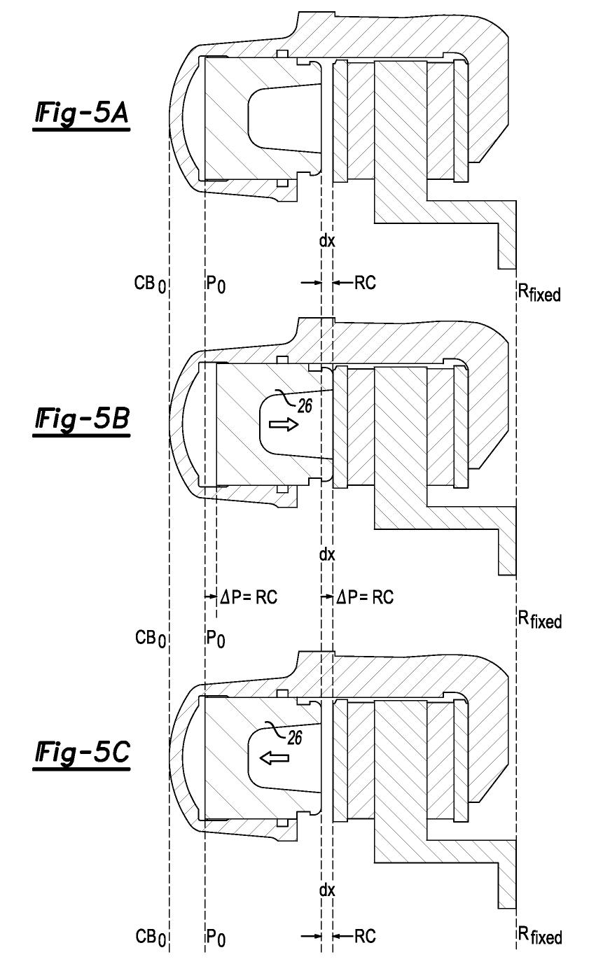

With reference to FIGS. 5-10, embodiments of the present invention are shown providing a braking scenario that includes an first brake-off position (A), a brake-on position (B), and a second brake-off position (C). The first brake-off position (FIGS. 5A, 7A, and 9A) provides the piston 26 and an initial running clearance RC. For simplicity of the discussion, the running clearance RC is shown to be the distance between the piston end and the inboard brake pad, however it is appreciated that there may is additional running clearance between the inboard and outboard brake pads and the rotor.

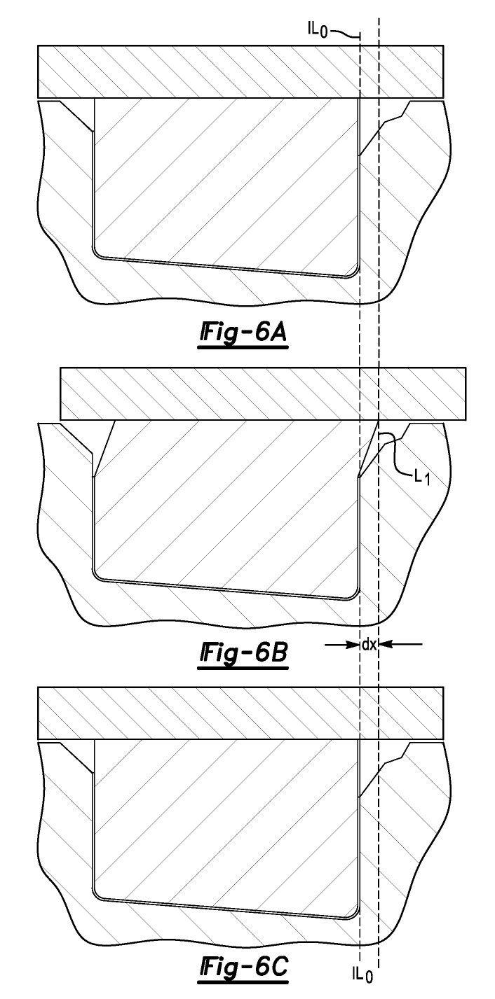

In one example, as the brake pedal is depressed, (e.g., brake-on position FIGS. 5B and 6B) the hydraulic pressure increases so as to extend the piston outward toward the rotor while deforming the seal into the second recess, each by a similar distance. More specifically, at a pressure from about 0 to about 1 MPa, a first portion 116 of the piston 26 extends outward from an initial location ILₒ (e.g., from vertical with respect to bore axis) to a first location L1 (e.g., from vertical with respect to bore axis) while deforming a forward portion 120 of the seal generally into the first area 110 of the second recess 102 (e.g., generally about the first area 110), each generally moving by a distance dX (FIGS. 5B and 6B).

Upon disengagement of the brakes, the hydraulic pressure decreases so as to allow the seal to substantially reform (via its intrinsic elastic characteristics) into the seal groove 62 while retracting the piston inward from the rotor such that the forward portion 120 of the seal and the first portion 116 of the piston move from the first location L1 to the initial location ILₒ (FIG. 6C), each, generally moving by a distance dX (FIGS. 5C and 6C). Accordingly, it is appreciated that the first angle 94 with respect to the first chamfered wall 84 may be configured to substantially prevent piston to seal slippage, so that upon achieving the second brake-off position (FIG. 5C) the running clearance RC has been substantially maintained.

It is appreciated for example that a portion of the seal may reassume to its normal position by bending about the second chamfered edge then the first chamfered edge. The first and second chamfered edges (e.g., bending points) effectively provide leverage to help retract the piston within the bore. It is believed that the seal may retract the piston generally proportional to the distance the piston extended outward during the brake-on position (e.g., at relatively low hydraulic pressures such as less than about 5 MPa).

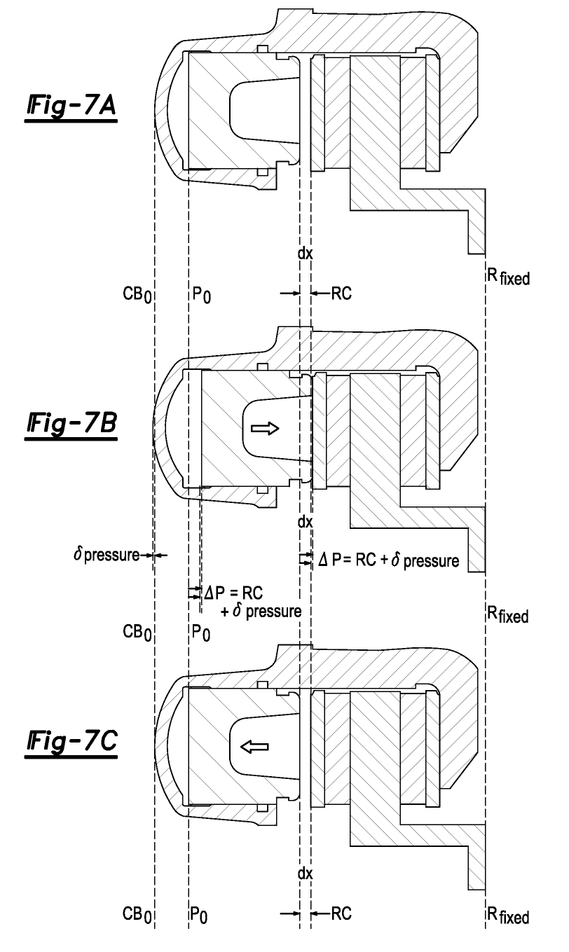

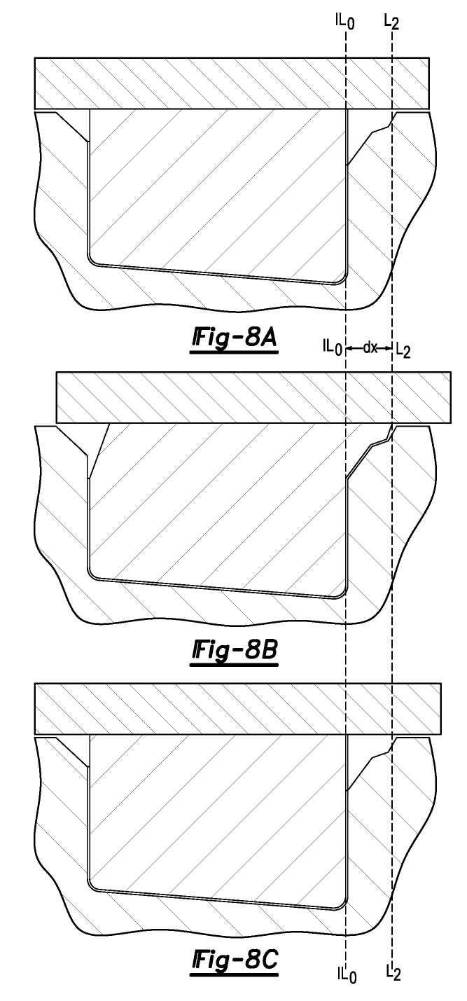

In another example, as the brake pedal is depressed (e.g., brake on position, FIGS. 7B and 8B), the hydraulic pressure increases so as to further extend the piston outward towards the rotor while further deforming the seal into the second recess, each by a similar distance. More specifically, at a pressure of less than about 5 MPa, the first portion 116 of the piston extends outward from the initial location ILₒ to a second location L2 (e.g., from vertical with respect to bore axis), typically beyond (e.g., outward) the first location L1, while deforming the forward portion of the seal 70 (FIG. 8B) into the second recess 102 (e.g., generally about the first area 110 or both the first and second areas 110, 112), both, generally moving a similar distance dX (FIGS. 7B and 8B).

Upon disengagement of the brakes, the hydraulic pressure decreases so as to allow the seal to substantially reform into the seal groove 62 while retracting the piston inward from the rotor. It is appreciated that the forward portion 120 of the seal and the first portion 116 of the piston move from the first location L1 to the initial location ILo (FIG. 6C), both, generally moving the similar distance dX (FIGS. 7C and 8C). Accordingly, it is appreciated that the angle 94 with respect to the first chamfered wall 84 and the angle 96 with respect to the second chamfered wall 86 may be configured to substantially prevent piston to seal slippage, so that upon achieving the second brake-off position (FIG. 7C) the running clearance RC has been substantially maintained.

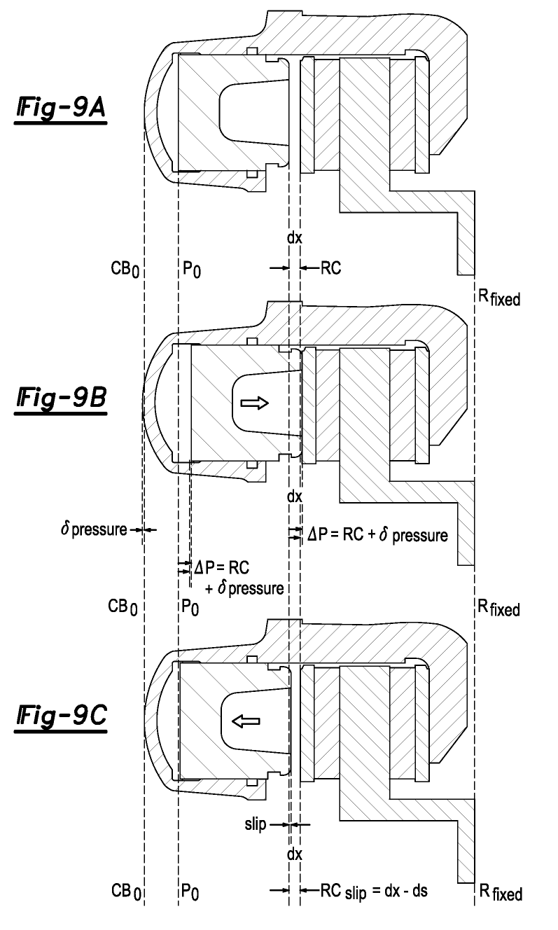

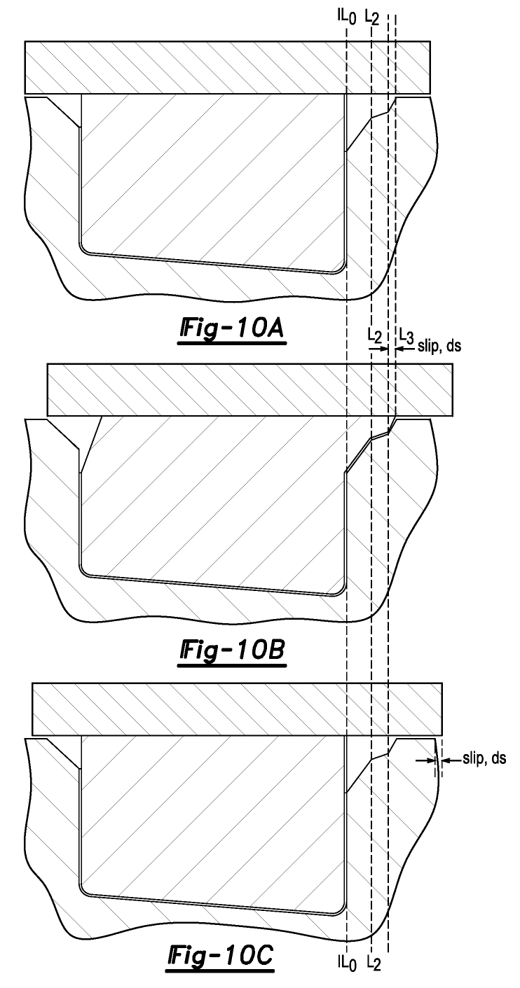

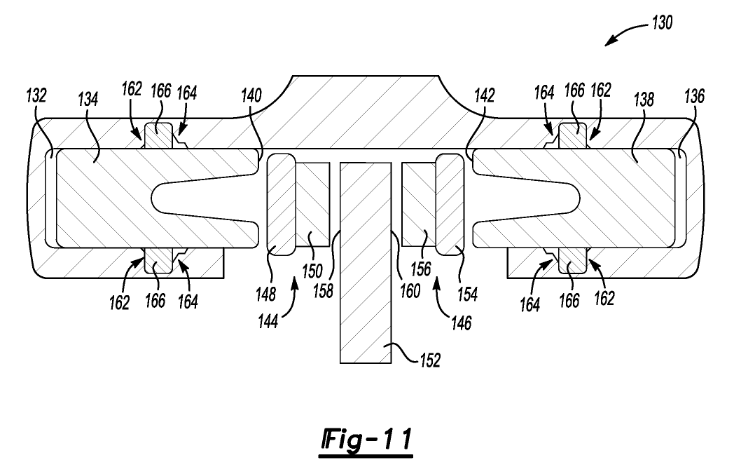

In yet another example, as the brake pedal is depressed (e.g., brake on position, FIGS. 9B and 10B), the hydraulic pressure increases so as to further extend the piston outward towards the rotor sufficiently to deform the seal such that the seal may contact the third chamfered wall 88. However, at increasing pressures and as the seal contacts the third chamfered wall 88, slippage occurs between the seal and the first portion 116 of the exterior surface of the piston. For example, as slippage occurs, the frictional contact that causes the seal to move with the piston may be overcome such that the first portion 116 of the piston continues to extend outward towards the rotor while the forward portion of the seal substantially ceases to further deform into the second recess (e.g., the third area 114).

More specifically, at a pressure of at least about 5 MPa, the first portion 116 of the piston extends outward from the initial location ILₒ to the location L2, while deforming the forward portion of the seal 70 (FIG. 10B) into the second recess 102 (e.g., generally about the first area 110 or both the first and second areas 110, 112), both, generally moving a similar distance dX (FIGS. 7B and 8B). However, at a pressure of about 5 MPa, the piston begins to slip from the seal thereby allowing the first portion 116 of the piston to extend beyond the forward portion 120 of the seal to a third location L3 (e.g., from vertical with respect to bore axis) by a distance dS (FIGS. 9B and 10B). It is appreciated that at the third location (e.g., dX+dS), the forward portion 120 of the seal is position about a second portion 118 of the piston. It is further appreciated that the distance dS that the first portion 116 slipped beyond the forward portion 120 of the seal is generally proportion to the distance between the first and second portions 116, 118 of the piston.

Upon disengagement of the brakes, the hydraulic pressure decreases such that the frictional contact between the seal and the exterior surface of the piston is substantially restored so as to prevent slippage. As such, the seal substantially reforms into the seal groove 62 while retracting the piston away from the rotor. As such, it is appreciated that the forward portion 120 of the seal and the second portion 118 of the piston move from the second location L2 to the initial location ILo (FIG. 6C), both, generally moving the similar distance dX while the first portion 116 generally moves from the third location L3 to a slip location LS that is a distance dX−dS (FIGS. 9C and 10C). Accordingly, it is appreciated that the third angle 100 with respect to the third chamfered wall 88 may be configured to allow piston to seal slippage generally by contact with the seal thereabout, so that upon achieving the second brake-off position (FIG. 9C) the running clearance RC has been decreased to a running clearance RCₛₗᵢₚ by the distance dS.

Advantageously, as a result of the decreased running clearance RCₛₗᵢₚ, in the following brake-on position (e.g., after the brake-off position, FIG. 10C), the distance necessary for the piston to extend to engage the brakes may be similarly decreased by the distance dS, thereby requiring less hydraulic fluid to achieve the necessary braking. By requiring less hydraulic pressure to achieve the necessary braking, the hydraulic fluid volume usage may be reduced.

It is contemplated that variances in the running clearance of the following second brake-off position may be affected by the amount of hydraulic pressure that was achieved in the previous brake-on position. In one aspect, at pressures ranging from about 0 to less than about 4 MPa or more, and preferably from about 1 to about 3 MPa (e.g., FIG. 5B), the profile of the first chamfered wall 84 substantially prevents slippage by allowing the seal to deform into the second recess 102 while maintaining the contact friction between the piston and the seal.

In another aspect, at pressures ranging from about 1 to about 7 MPa or more, and preferably from about 2 to about 6 MPa, the profile of the first chamfered wall 84 (e.g., from about 0 to about 3 MPa) or both the profile of the first and second chamfered walls 84, 86 (e.g., about 2 to about 7 MPa) substantially prevents slippage by allowing the seal to deform into the second recess 102 while maintaining the contact friction between the piston and the seal.

It is appreciated that at pressures ranging from about 0 to about 7 MPa in a brake-on position (FIGS. 5B and 7B), the running clearance RC in the following second brake-off position (FIGS. 5C and 7C) is substantially maintained with respect to the initial first brake-on position (FIGS. 5A and 7A). As such, the running clearance RC may be at least about 0.05 mm, though possibly less, and preferably at least about 0.5 mm.

Advantageously, the profile of the third chamfered wall 88 may be located such as to allow slippage at a pressure of at least about 6 MPa, though possibly less. At this pressure, the second chamfered edge 92 with respect to the third chamfered wall 88, the third angle 100, or both may allow slippage to occur thereby generally preventing the seal 70 to continue to deform into the second recess 102 (e.g., the third area 114) as previously necessary so as to maintain the initial (e.g., constant) running clearance RC in the following (e.g., second) brake-off position. It is believed that as pressure increases above 6 MPa, the first portion 116 of the piston may continue to extend outwards beyond the forward surface 120 of the seal towards the rotor until a maximum brake pedal depression (e.g., maximum pressure and/or brake engagement) has been reached, the brake pedal has been disengaged, or both. Typically, at the maximum brake pedal depression (e.g., total piston stroke), the pressure may be at least about 10 MPa, or more (e.g., 14 MPa).

Accordingly, in the following brake-off position, (FIGS. 9C and 10C) (e.g., after a brake-on position with piston to seal slippage, FIGS. 9B and 10B), the running clearance RC will have decreased to the running clearance RCₛₗᵢₚ corresponding to hydraulic pressure obtained in the previous brake-on position. It is appreciated that the hydraulic pressure of at least about 5 MPa, and preferably at least about 7 MPa in the previous brake-on position with slippage (e.g., FIGS. 9B and 10B), the running clearance RCₛₗᵢₚ may be less than about 0.5 mm, though possibly more, and preferably less than about 0.1 mm. It is contemplated that as the hydraulic pressure increases above at least about 7 MPa thereby allowing slippage to continue in the brake-on position, the running clearance RCₛₗᵢₚ, upon returning to following brake-off position, may substantially approach 0 mm (e.g., at a hydraulic pressure of at least about 10 MPa).

It is appreciated that various grove seal designs have been are provided in U.S. Pat. Nos. 3,915,461; 4,387,901; 5,076,593; 5,325,940; 6,244,393; and 7,255,207; and US Patent Application 20070256903, which are herein incorporated by reference for all purposes.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. A disc caliper apparatus of a brake assembly comprising
a. at least one piston bore including a first piston bore having an exterior surface and a first seal groove that includes a groove wall defining a first recess into the exterior surface of the first piston bore; wherein the groove wall includes a forward groove wall portion nearest to an inboard brake pad and an opposing rearward groove wall portion;
b. at least one piston including a first piston slidably positioned within the first piston bore for movement along a first bore axis, the first piston having an exterior surface and a first piston end configured for moving the inboard brake pad;
c. a first seal arranged about the first recess of the first seal groove, which frictionally engages for sealing purposes on a first portion of the exterior surface of the first piston;
d. a first chamfered wall portion including a plurality of chamfered walls that adjacently extend from an inner end of the forward groove wall portion to a forward portion of the exterior surface of the first piston bore, the plurality of chamfered walls include:
i) a first chamfered wall extending from the second end of the inner groove wall portion to a first chamfered edge;
ii) a second chamfered wall extending from the first chamfered edge to a second chamfered edge; and
iii) a third chamfered wall extending from the second chamfered edge to an edge portion of the exterior surface of the first piston bore;
wherein a first brake-off position includes an initial first running clearance;
wherein the third chamfered wall is configured to allow slippage between the first seal and the first portion of the exterior surface of the first piston during a brake-on position such that in a following second brake-off position the initial running clearance is decreased.

2. The apparatus of claim 1, wherein slippage between the first seal and the first portion of the exterior surface of the first piston occur during the brake-on position at a pressure of at least about 5 MPa.

3. The apparatus of claim 1, wherein the third chamfered wall defines a third angle that ranges from about 0° to about 45° taken from vertical with respect to the first bore axis.

4. The apparatus of claim 3, wherein the first chamfered wall defines a first angle that ranges from about 5° to about 50° taken from vertical with respect to the first bore axis.

5. The apparatus of claim 4, wherein the second chamfered wall defines a second angle that ranges from about 50° to about 90° taken from vertical with respect to the first bore axis.

6. The apparatus of claim 5, wherein the third angle is smaller than the first angle, the second angle, or both.

7. The apparatus of claim 1, wherein the first chamfered wall is configured to substantially prevent slippage between the first seal and the first portion of the exterior surface of the first piston at a pressure of at least about 2 MPa during the brake-on position and upon removal of the pressure, the initial first running clearance is substantially maintained in the following second brake-off position.

8. The apparatus of claim 7, wherein the inboard brake pad and an outboard brake pad are generally high stiffness brake pads, the first chamfered wall allows the first seal to generally deform into at least a first portion of the first recess as the first piston extends towards the rotor during the brake-on position such that the first seal substantially moves with the first piston due to contact friction, increasing pressure on the seal, or both and wherein slippage is substantially prevented at hydraulic pressures less than about 5 MPa and slippage occurs at hydraulic pressures greater than about 5 MPa.

9. The apparatus claim 7, wherein the inboard brake pad and an outboard brake pad are generally low stiffness brake pads, the first and second chamfered walls are configured to allow the seal to generally deform through a first portion of the first recess and into a second portion of the first recess as the first piston extends towards the rotor during the brake-on position such that the seal substantially moves with the first piston due to contact friction, increasing pressure on the seal, or both and wherein slippage is substantially prevented at hydraulic pressures less than about 5 MPa and the first seal generally deforms about the third chamfered wall at hydraulic pressures greater than about 5 MPa such that slippage occurs.

10. The apparatus of claim 1, wherein
a. the at least one piston bore further includes a second piston bore having an exterior surface and a second seal groove that includes a groove wall defining a second recess into the exterior surface of the second piston bore; wherein the groove wall includes a forward groove wall portion nearest to the outboard brake pad and an opposing rearward groove wall portion;
b. the at least one piston further including a second piston slidably positioned within the second piston bore for movement along a second bore axis, the second piston having an exterior surface and a second piston end configured for moving the outboard brake pad;
c. a second seal arranged about the second recess of the second seal groove, which frictionally engages for sealing purposes on a first portion of the exterior surface of the second piston;
d. a second chamfered wall portion including a plurality of chamfered walls that adjacently extend from an inner end of the forward groove wall portion to a forward portion of the exterior surface of the second piston bore, the plurality of chamfered walls include:
i) a fourth chamfered wall extending from the first end of the inner groove wall portion to a third chamfered edge;
ii) a fifth chamfered wall extending from the third chamfered edge to a fourth chamfered edge; and
iii) a sixth chamfered wall extending from the fourth chamfered edge to an edge portion of the exterior surface of the second piston bore;
wherein the first brake-off position includes the initial first running clearance that is defined by the distance between the first end and the rotor and the distance between the second piston end and the rotor;
wherein the third chamfered wall is configured to allow slippage between the first seal and the first portion of the exterior surface of the first piston during a brake-on position such that in the following second brake-off position the initial running clearance between the first piston and the rotor is decreased;
wherein the sixth chamfered wall is configured to allow slippage between the second seal and the first portion of the exterior surface of the second piston during a brake-on position such that in a following second brake-off position the initial running clearance between the second piston and the rotor is decreased; and
wherein the first piston is generally spaced apart from and opposing the second piston such that in the brake-on position the first piston end moves the inboard brake shoe and the second piston end moves the outboard brake shoe inward toward the rotor located therebetween.

11. A disc caliper apparatus of a brake assembly comprising:
a. at least one piston bore having an exterior surface and a seal groove that includes a groove wall defining a recess into the exterior surface of the at least one piston bore, wherein the groove wall includes a forward groove wall portion nearest to an inboard brake pad, and an opposing rearward groove wall portion, the forward and rearward groove wall portions each having a first end extending to an outer groove wall portion therebetween;
b. at least one piston slidably positioned within the at least one piston bore for movement along a bore axis, the at least one piston having an exterior surface and a piston end configured for moving the inboard brake pad;
c. a seal arranged about the recess of the seal groove, which frictionally engages for sealing purposes on a first portion of the exterior surface of the at least one piston;
d. a plurality of chamfered walls that adjacently extend in series from a second end of the forward groove wall portion to the exterior surface of the at least one piston bore, the plurality of chamfered walls include:
i) a first chamfered wall extending from the second end of the inner groove wall portion to a first chamfered edge, the first chamfered wall defining a first angle that ranges from about 5° to about 50° taken from vertical with respect to the bore axis;
ii) a second chamfered wall extending from the first chamfered edge to a second chamfered edge, the second chamfered wall defining a second angle that ranges from about 50° to about 90° taken from vertical with respect to the bore axis;
iii) a third chamfered wall extending from the second chamfered edge to an edge portion of the exterior surface of the at least one piston bore, the third chamfered wall defining a third angle that ranges from about 0° to about 45° taken from vertical with respect to the bore axis;
wherein a first brake-off position includes an initial running clearance; and
wherein the third chamfered wall is configured to allow slippage between the seal and the first portion of the exterior surface of the at least one piston at a pressure of at least about 5 MPa during a brake-on position for brake assemblies of varying stiffness such that in a second brake-off position the initial running clearance is decreased.

12. The apparatus of claim 11, wherein the inboard brake pad and an outboard brake pad are generally high stiffness brake pads, the first chamfered wall allows the seal to generally deform into a first portion of the recess as the at least one piston extends towards the brake pads to apply a clamping force during the brake-on position such that the seal substantially moves with the at least one piston due to contact friction, increasing pressure on the seal, or both and wherein slippage is substantially prevented at hydraulic pressures less than about 5 MPa and slippage occurs as the seal generally deforms about the third chamfered wall at hydraulic pressures greater than about 5 MPa.

13. The apparatus of claim 12, wherein the first chamfered wall is configured to substantially prevent slippage between the seal and the first portion of the exterior surface of the at least one piston at a pressure of at least about 2 MPa in the brake-on position and upon removal of the pressure, the initial running clearance is substantially maintained in the following second brake-off position.

14. The apparatus of claim 13, wherein the inboard brake pad and an outboard brake pad are generally low stiffness brake pads, the first and second chamfered walls are configured to allow the seal to generally deform into the first portion or both the first portion and a second portion of the recess as the at least one piston travels towards the brake pads to apply a clamping force on the rotor during the brake-on position such that the seal substantially moves with the at least one piston due to contact friction, increasing pressure on the seal, or both and wherein slippage is substantially prevented at hydraulic pressures less than about 5 MPa and slippage occurs as the seal generally deforms about the third chamfered wall at hydraulic pressures greater than about 5 MPa.

15. The apparatus of claim 14, wherein the seal deforms into the second portion of the recess about the second chamfered wall, the pressure ranges from about 2 MPa to about 7 MPa, or both during the brake-on position and upon removal of pressure, the initial running clearance is substantially maintained in the following second brake-off position.

16. The apparatus of claim 15, wherein at a pressure less than about 7 MPa, the first and second angles are configured to substantially prevent slippage between the seal and the first portion of the exterior surface of the at least one piston so that piston retraction is substantially maintained irrespective of fluid pressure.

17. The apparatus of claim 11, wherein the seal deforms into the first portion of the recess about the first chamfered wall, the pressure increases from about 0 to about 3 MPa, or both in the brake-on position and upon removal of pressure, the initial running clearance is substantially maintained in the following second brake-of position.

18. The apparatus of claim 11, wherein the third angle is smaller than the first angle, the second angle, or both.

19. A disc caliper apparatus of a brake assembly comprising:
at least one piston bore having an exterior surface and a seal groove that includes a groove wall defining a recess into the exterior surface of the at least one piston bore, wherein the groove wall includes:
a. a rearward groove wall portion having an inner end with an angled wall that extends to a rearward portion of the exterior surface of the at least one piston bore;
b. a forward groove wall portion nearest to an inboard brake pad, being spaced apart from and generally opposing the rearward groove wall portion, the forward groove wall includes an inner end with a plurality of chamfered walls that adjacently extend in series from the inner end of the forward groove wall portion to a forward portion of the exterior surface of the at least one piston bore, the plurality of chamfered walls include:
i) a first chamfered wall extending from the inner end of the forward groove wall portion to a first chamfered edge, the first chamfered wall defining a first angle that ranges from about 25° to about 45° taken from vertical with respect to a bore axis;
ii) a second chamfered wall extending from the first chamfered edge to a second chamfered edge, the second chamfered wall defining a second angle that ranges from about 50° to about 70° taken from vertical with respect to the bore axis; and
iii) the third chamfered wall extending from the second chamfered edge to an edge portion of the forward portion of the exterior surface of the at least one piston bore, the third chamfered wall defining a third angle that ranges from about 5° to about 45° taken from vertical with respect to the bore axis;
c. an outer groove wall extending between outer ends of the forward and rearward groove wall portions, a first outer end of the forward groove wall portion is further displaced than a second outer end of the rearward groove wall portion such that the outer groove wall is sloped with respect to the bore axis;
at least one piston slidably positioned within the at least one piston bore for movement along the bore axis;
a seal arranged about the seal groove, which frictionally engages for sealing purposes on the exterior surface of the at least one piston;
wherein a first brake-off position includes an initial running clearance;
wherein the first chamfered wall is configured to substantially prevent seal to piston slip at a pressure range of about 0 to about 2 MPa during a brake-on position and upon removal of pressure, the initial running clearance is substantially maintained in a following second brake-off position;
wherein the second chamfered wall is configured to substantially prevent seal to piston slip at a pressure range of about 2 to about 4 MPa during the brake-on position and upon removal of pressure, the initial running clearance is substantially maintained in the following second brake-off position; and
wherein the third chamfered wall is configured to allow slippage between the seal and the first portion of the exterior surface of the at least one piston at a pressure of at least about 5 MPa during the brake-on position for brake assemblies of varying stiffness such that in a second brake-off position the initial running clearance is decreased.

20. The apparatus of claim 19, wherein the third angle is smaller than the first angle, the second angle, or both.
